(19) United States
(12) Patent Application Publication
(10) Pub. No.: US 2023/0072738 A1
(43) Pub. Date: Mar. 9, 2023

(54) METHOD OF MANUFACTURING ANTIBACTERIAL MOBILE PHONE CASE USING TPU ANTIBACTERIAL MASTERBATCH

(71) Applicants: Seung Suk CHO, Seogwipo-si (KR); OLOR CO., LTD, Seoul (KR)

(72) Inventors: Seung Suk CHO, Seogwipo-si (KR); Jung Jae CHOI, Hwaseong-si (KR); Kwang Won JUNG, Seoul (KR); Byung Hoon HWANG, Seoul (KR); Chang Soo CHOI, Goyang-si (KR)

(21) Appl. No.: 17/750,211

(22) Filed: May 20, 2022

(30) Foreign Application Priority Data
Sep. 9, 2021 (KR) 10-2021-0120418

(51) Int. Cl. B29C 45/00; B29C 45/18; B29C 45/60; B29C 45/47

(52) U.S. Cl. CPC B29C 45/0001; B29C 45/1816; B29C 45/60; B29C 45/47; B29K 2995/002; B29K 2105/0032

(57) ABSTRACT

Proposed is a method of manufacturing an antibacterial mobile phone case using a TPU antibacterial masterbatch. The method includes: (a) preparing an antibacterial masterbatch by dispersing an antibacterial agent and an additive in thermoplastic polyurethane and then performing extrusion molding; (b) preparing an antibacterial masterbatch by dispersing an antibacterial agent and an additive in thermoplastic polyurethane and then performing extrusion molding; (c) dispersing and mixing the color masterbatch prepared in step (a) in thermoplastic polyurethane; (d) dispersing and mixing the antibacterial masterbatch prepared in step (b) in thermoplastic polyurethane; and (e) dispersing the material mixed in step (c) and the material mixed in step (d) and then performing injection molding.

### CROSS REFERENCE TO RELATED APPLICATION

The present application claims priority to Korean Patent Application No. 10-2021-0120418, filed Sep. 9, 2021, the entire contents of which is incorporated herein for all purposes by this reference.

### BACKGROUND OF THE INVENTION

### Field of the Invention

The present disclosure relates to a method of manufacturing an antibacterial mobile phone case using a TPU antibacterial masterbatch.

### Description of the Related Art

Unless otherwise indicated herein, the approaches described in this section are not teachings or suggestions of the prior art to the claims in this application and are not admitted to be prior art by inclusion in this section.

With the prolonged global outbreak of COVID-19 infectious disease, people's concerns about infections and hygiene are increasing. In response, antibacterial films are being installed on public elevators and door handles in public offices, corporations, apartments, etc. where surfaces are touched by many people. In addition, the popularity and consumption of various antibacterial products such as smartphone antibacterial films, antibacterial deodorants, antibacterial masks, and antibacterial gloves are gradually increasing. In particular, with the recent signs that the second wave of COVID-19 is spreading, sterilizers that sterilize personal belongings such as glasses, earphones, and accessories have appeared. Also, as interest in the hygiene and sterilization of smartphones that have become a part of daily life grows, the demand for sterilization products exclusively for smartphones has increased explosively. In order to meet this demand, manufacturers of the products are striving to research and develop products to produce better quality products.

As an example of the related technology, Patent Document 1 discloses: a protect cover for a mobile terminal including a cover layer, an adhesive layer laminated on an inner surface of the cover layer, and a metal layer attached to the adhesive layer to perform an electromagnetic wave shielding function; and a method of manufacturing the same protective cover. As another example, Patent Document 2 discloses a health-friendly mobile phone case including: an injection-molded case body made of a polymeric material containing substances with far-infrared radiation, anion radiation and antibacterial functions; a primer coating layer formed on the injection-molded case body and made of an organic or inorganic composite material containing substances with far-infrared radiation, anion radiation, and antibacterial functions; and an organic coating layer formed on the primer coating layer to enhance slip properties and hydrophilicity.

The technique described in Patent Document 1 has a drawback in that since a pigment is mixed with a silver nano material, a polymer, and a solvent in the preparation of a spinning solution, it is difficult to properly exhibit the antibacterial performance of the silver nano material due to the use of the pigment. Also, the technique described in Patent Document 2 has a drawback in that since a dye is mixed with a polymer and nano gold/silver in the formation of the primer coating layer, it is difficult to properly exhibit the antibacterial performance of the nano gold/silver due to the use of the dye.

The foregoing is intended merely to aid in the understanding of the background of the present disclosure, and is not intended to mean that the present disclosure falls within the purview of the related art that is already known to those skilled in the art.

### DOCUMENTS OF RELATED ART

(Patent document 1) Korean Patent Application Publication No. 10-2014-0101675(2014 Aug. 20)
(Patent document 2) Korean Patent Application Publication No. 10-2007-0025416(2007 Mar. 8)

### SUMMARY OF THE INVENTION

Accordingly, the present disclosure has been made keeping in mind the above problems occurring in the related art, and an objective of the present disclosure is to provide a method of manufacturing an antibacterial mobile phone case using a TPU antibacterial masterbatch, in which a color masterbatch and an antibacterial masterbatch are individually prepared, then thermoplastic polyurethane and the color masterbatch are mixed in a first mixer, then thermoplastic polyurethane and the antibacterial masterbatch are mixed in a second mixer, and finally the mixture of first mixer and the mixture of the second mixer are mixed in an injection molder. Thereby, it is possible to minimize the process of mixing the color masterbatch and the antibacterial masterbatch to thereby improve antibacterial performance.

The objectives of the present disclosure are not limited to those mentioned above, and other objectives not mentioned will become apparent from the following description.

In order to achieve the above objective, according to one aspect of the present disclosure, there is provided a method of manufacturing an antibacterial mobile phone case using a TPU antibacterial masterbatch, the method including: (a) preparing an antibacterial masterbatch by dispersing an antibacterial agent and an additive in thermoplastic polyurethane and then performing extrusion molding; (b) preparing an antibacterial masterbatch by dispersing an antibacterial agent and an additive in thermoplastic polyurethane and then performing extrusion molding; (c) dispersing and mixing the color masterbatch prepared in step (a) in thermoplastic polyurethane; (d) dispersing and mixing the antibacterial masterbatch prepared in step (b) in thermoplastic polyurethane; and (e) dispersing the material mixed in step (c) and the material mixed in step (d) and then performing injection molding.

In step (a), 25 to 35 parts by weight of the pigment and 10 to 20 parts by weight of the additive may be dispersed in 100 parts by weight of the thermoplastic polyurethane.

In step (b), 25 to 35 parts by weight of the antibacterial agent and 10 to 20 parts by weight of the additive may be dispersed in 100 parts by weight of the thermoplastic polyurethane.

In step (c), 1 to 10 parts by weight of the color masterbatch may be dispersed in 100 parts by weight of the thermoplastic polyurethane.

In step (d), 1 to 15 parts by weight of the antibacterial masterbatch may be dispersed in 100 parts by weight of the thermoplastic polyurethane.

Step (c) may be performed by a first mixer. The first mixer may include: a first body having a screw coupled therein and including a first inlet and a first outlet; and a first hopper coupled to the first inlet and configured to supply the color masterbatch prepared in step (a).

Step (d) may be performed by a second mixer. The second mixer may include: a second body having a screw coupled therein and including a second inlet and a second outlet; and a second hopper coupled to the second inlet and configured to supply the antibacterial masterbatch prepared in step (b).

The first mixer may further include a first defoamer supplier configured to supply a defoamer to the first body.

Step (e) may be performed by an injection molder including a single screw. The injection molder may include: a cylinder having a single screw coupled therein and including an injection inlet and an injection outlet; a first connector having a first side connected to the first outlet of the first body and a second side connected to the cylinder, and configured to supply the material mixed in the first mixer to the cylinder; a second connector having a first side connected to the second outlet of the second body and a second side connected to the cylinder, and configured to supply the material mixed in the second mixer to the cylinder; and a molding die connected to a nozzle coupled to the injection outlet.

The injection molder may further include a third defoamer supplier configured to supply a defoamer to the cylinder.

The injection molder may further include a sensor configured to open and close each of the first and second connectors by measuring temperature, pressure, and composition ratio inside the cylinder.

In the method of manufacturing the antibacterial mobile phone case using the TPU antibacterial masterbatch, the color masterbatch and the antibacterial masterbatch are individually prepared, then thermoplastic polyurethane and the color masterbatch are mixed in the first mixer, then thermoplastic polyurethane and the antibacterial masterbatch are mixed in the second mixer, and finally the mixture of first mixer and the mixture of the second mixer are mixed in the injection molder. Thereby, it is possible to minimize the process of mixing the color masterbatch and the antibacterial masterbatch to thereby prevent the antibacterial performance from deteriorating by coating an antibacterial agent with a pigment.

Furthermore, the process of mixing the color masterbatch with the thermoplastic polyurethane and the process of mixing the antibacterial masterbatch with the thermoplastic polyurethane are separately performed in the first mixer and the second mixer 200, respectively. Thus, it is possible to minimize the time for mixing the color masterbatch and the antibacterial masterbatch to thereby further improve the antibacterial durability and performance.

Furthermore, the present disclosure has the advantage of being eco-friendly and harmless to human body by upcycling the discarded shells of oyster, scallop, blood cockle, Asian hard clam, mussel, Manila clam, common cockle, Chinese venus clam, pen shell, razor clam, Asian clam, and abalone, which are dumped into ocean or left on land and are considered the main culprits of coastal pollution, as a raw material for cell phone cases.

Furthermore, the defoamer supplier can improve the product quality by removing air bubbles resulting when mixing the color masterbatch and the antibacterial masterbatch with the thermoplastic polyurethane.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a process diagram illustrating a method of manufacturing an antibacterial mobile phone case using a TPU antibacterial masterbatch according to an embodiment of the present disclosure;

FIG. 2 is an overall schematic view illustrating a facility used in an injection molding process;

FIG. 3 is a schematic view illustrating a mixer;

FIG. 4 is a schematic view illustrating an injection molder;

FIG. 5 is an image illustrating an antibacterial jelly case of Example 1 cut to a size of 50 cm×50 cm; and

FIGS. 6 to 10 are test reports and images illustrating the antibacterial performance evaluation results of Experimental Example 1.

### DETAILED DESCRIPTION OF THE INVENTION

Hereinafter, the configuration and operational effects of an exemplary embodiment of the disclosure will be described with reference to the accompanying drawings. For reference, in these drawings, each component is omitted or schematically illustrated for convenience and clarity, and the size of each component does not reflect the actual size. The same reference numerals will refer to the same or like parts throughout the drawings, and reference numerals for the same or like parts in individual drawings will be omitted.

Hereinafter, a method of manufacturing an antibacterial mobile phone case using a TPU antibacterial masterbatch disclosed in the present specification will be described in detail with reference to the drawings.

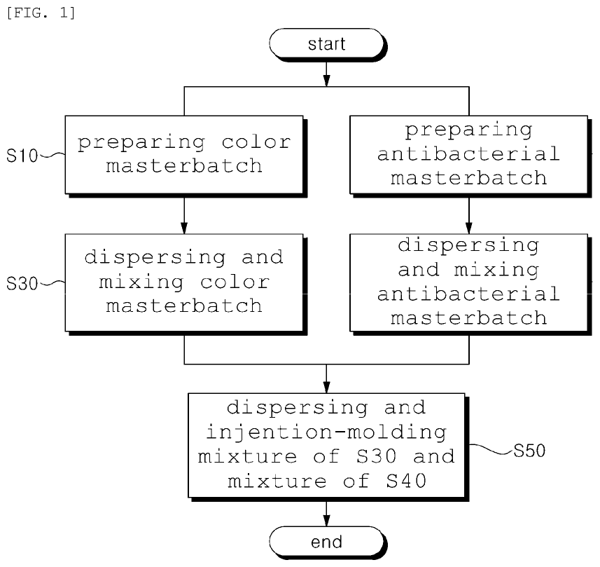

FIG. 1 is a process diagram illustrating a method of manufacturing an antibacterial mobile phone case using a TPU antibacterial masterbatch according to an embodiment of the present disclosure.

Referring to FIG. 1, first, a pigment and an additive are dispersed in thermoplastic polyurethane and then subjected to extrusion molding to prepare a color masterbatch (S10).

The color masterbatch may be prepared by dispersing 25 to 35 parts by weight of the pigment, preferably 27 to 30 parts by weight, and 10 to 20 parts by weight, preferably 13 to 16 parts by weight of the additive in 100 parts by weight of the thermoplastic polyurethane using a twin-screw extruder and then extrusion-molding the resultant material.

The thermoplastic polyurethane (TPU) consists of a soft phase and a hard phase and can polymerize various hardness elastomers according to the ratio of the two phases through block copolymerization. The TPU has the highest mechanical properties among thermoplastic elastomers due to the strong urethane interaction between polymer chains, and also has excellent chemical resistance such as oil resistance and fuel resistance.

The TPU can be applied to various automobile parts that require wear resistance, scratch resistance, and soft-touch properties, and enables weight reduction and NVH performance improvement due to its excellent properties and flexibility. In addition, applications include agriculture, consumer goods, oil/gas exploration, transportation, films/sheets, electronics, industrial components, wire/cable sheathing, hoses/tubes, wheel, soft-touch overmolding, polymer modifiers, food processing, recreation, footwear, etc. Currently, in Korea, the TPU is widely used in industrial sheets, screen protection films, sanitary cutting boards, and automotive ABS brake sensor cables.

The pigment is not particularly limited in use. As the pigment, either of an inorganic pigment and an organic pigment can be used, and any color pigment can be used. Pigments are generally classified into a self-dispersing pigment dispersion that is insoluble and in which a dispersing functional group is attached to the surface of a pigment through a special chemical reaction, and a polymer dispersion in which a polymer is dispersed in a medium using a polymer dispersant. Examples of the organic pigment include azo-based, phthalocyanine-based, dye-based, condensed polycyclic-based, quinacridone-based, nitro- and nitroso-based pigments, and a black pigment such as carbon black, lamp black, acetylene black, and channel black. Examples of the inorganic pigment include metals such as cobalt, iron, chromium, copper, zinc, lead, titanium, vanadium, manganese and nickel, metal oxides, and sulfides.

Examples of a magenta pigment include: C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 178, 179, 184, 185, 187, 202, 209, 219, and 245; and C.I. Pigment Violet 19, 23, 32, 33, 36, 38, 43, and 50.

Examples of a yellow pigment include I. C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 114, 117, 120, 124, 128, 129, 133, 138, 139, 147, 151, 153, 154, 167, 172, and 180.

Examples of a cyan pigment include I. C.I. Pigment Blue 1, 2, 3, 15, 15:1, 15:2, 15:3, 15:34, 15:4, 16, 18, 22, 25, 60, 65, and 66.

Examples of a pigment other than the magenta, yellow, and cyan pigments include: C.I. Pigment Green 7 and 10; C.I. Pigment Brown 3, 5, 25, and 26; and C.I. Pigment Orange 1, 2, 5, 7, 13, 14, 15, 16, 24, 34, 36, 38, 40, 43, and 63.

Examples of carbon black to be used as black pigments include: MCF88, No. 2300, 2200 B, 900, 33, 40, 45, 52, MA7, 8, and 100 (the mentioned above are all trade names, manufactured by Mitsubishi Chemical Corporation); Raven 5750, 5250, 5000, 3500, 1255, 700 (the mentioned above are all trade names, manufactured by Columbia Carbon Corporation); Regal 400 R, 330 R, 660 R, Mogul L, Monarch 700, 800, 880, 900, 1000, 1100, 1300, and 1400 (the mentioned above are all trade names, manufactured by Cabot Corporation); Color Black FW1, FW2, FW2V, FW18, FW200, 5150, 5160, and 5170; Printex 35, U, V, and 140 U; and Special Black 6, 5, 4A, and 4 (the mentioned above are all trade names, manufactured by Degussa Corporation).

The pigment may be used alone or in combination with other pigments.

Meanwhile, the mean grain size of the pigment may be in the range of 0.005 to 15 μm, preferably 0.05 to 5 μm. When the mean grain size of the pigment is less than 0.005 μm, the pigment may be difficult to disperse in the thermoplastic polyurethane and fluidity may deteriorate. On the other hand, when the mean grain size of the pigment exceeds 15 μm, it may be difficult to express a desired color.

The pigment may be included in an amount of 25 to 35 parts by weight, preferably 27 to 30 parts by weight, with respect to 100 parts by weight of the thermoplastic polyurethane. This is because, when the amount of the pigment is less than 25 parts by weight, it may be difficult to express a desired color, and on the other hand, when the amount of the pigment exceeds 35 parts by weight, moldability may deteriorate due to an increase in viscosity.

Examples of the additive include a plasticizer, an antioxidant, a heat stabilizer, a UV stabilizer, a flame retardant, a filler, a nucleating agent, a defoamer, a lubricant, an antistatic agent, a foaming agent, an impact modifier, a crosslinking agent, a dispersant, a surfactant, a deodorant, and the like, and preferably include an antioxidant and a dispersant. The additive may be included in an amount of 10 to 20 parts by weight, preferably 13 to 16 parts by weight, with respect to 100 parts by weight of the thermoplastic polyurethane. This is because, when the amount of the additive is less than 10 parts by weight, physical properties and mechanical strength may deteriorate, and when the amount of the additive exceeds 20 parts by weight, the amount of other components is less than that of the additive and is insufficient to act as a binder, causing a deterioration in mechanical strength.

The antioxidant may be added to inhibit or block a chemical reaction between plastic and oxygen, thereby preventing loss of physical properties due to degradation of the plastic. As the antioxidant, at least one selected from the group consisting of phenol-based, amine-based, sulfur-based, and phosphorus-based antioxidants may be used.

The heat stabilizer may be added to inhibit or block thermal degradation of plastic during mixing or molding at high temperatures. As the heat stabilizer, at least one selected from the group consisting of Cd/Ba/Zn-based, Cd/Ba-based, Ba/Zn-based, Ca/Zn-based, Na/Za-based, Sn-based, Pb-based, Cd-based, and Zn-based heat stabilizers may be used.

The UV stabilizer may be added to inhibit or block color degeneration or loss of physical properties due to degradation of plastic from UV rays. As the UV stabilizer, at least one selected from the group consisting of carbon black, titanium dioxide (TiO₂), benzotriazole, and nickel-chelate may be used.

The flame retardant may be added to reduce combustibility of plastic. As the flame retardant, at least one selected from the group consisting of halogen-based, phosphorus-based, and inorganic-based flame retardants may be used.

The filler may be added as a bulking agent added in large quantities to reduce cost and a reinforcing agent added to improve mechanical, thermal, and electrical properties or processability. As the filler, at least one selected from the group consisting of silica (SiO₂), aluminum oxide, magnesium oxide, calcium oxide, aluminum hydroxide, magnesium hydroxide, calcium hydroxide, carbon, talc, zirconia (zirconium oxide), antimony oxide, and rubber may be used.

The nucleating agent may be added to accelerate a crystallization rate of plastic, reduce a crystal size, thereby improving transparency, increase a crystallization rate, thereby shortening a cycle time, and improve physical properties.

The foaming agent may be added to reduce the weight of plastic and increase thermal insulation and shock absorption. As the foaming agent, at least one selected from the group consisting of magnesium hydroxide, azodicarbonamide, oxydibenzenesulfonylhydrazide (OBSH), p-toluenesulfonyl hydrazide, sodium bicarbonate, hydrocarbon, and ethylene-vinyl acetate (EVA) may be used.

The defoamer may be added to remove harmful air bubbles. As the defoamer, there may be used an oil substance with low volatility and high diffusibility or a water-soluble surfactant, preferably a mixture of: 100 parts by weight of at least one fatty acid alcohol selected from the group consisting of lauryl alcohol, cetyl alcohol, stearyl alcohol, oleyl alcohol, decyl alcohol, and dodecyl alcohol; 1 to 10 parts by weight of a fatty acid having 15 to 20 carbon atoms; 50 to 80 parts by weight of at least one nonionic surfactant selected from the group consisting of sorbitan fatty acid ester, glycerin fatty acid ester, polyglycerin fatty acid ester, propyl polyoxyethylene alkylphenyl ether, polyoxyethylene fatty acid ester, polyoxyethylene sorbitan fatty acid ester, polyoxyethylene glycerin fatty acid ester, and polyoxyethylene propylene glycol fatty acid ester; 40 to 70 parts by weight of at least one vegetable oil selected from the group consisting of soybean oil, palm oil, corn oil, and rice bran oil; and 30 to 50 parts by weight of at least one mineral oil selected from the group consisting of mineral oil, paraffin oil, and petrolatum, but the present disclosure is not limited thereto.

As the surfactant, at least one selected from the group consisting of an anionic surfactant, a cationic surfactant, a nonionic surfactant, and a fluorine-based surfactant may be used.

An antibacterial agent and an additive are dispersed in thermoplastic polyurethane and then subjected to extrusion molding to prepare an antibacterial masterbatch (S20).

The antibacterial masterbatch may be prepared by dispersing 25 to 35 parts by weight of the antibacterial agent, preferably 27 to 30 parts by weight, and 10 to 20 parts by weight, preferably 13 to 16 parts by weight of the additive in 100 parts by weight of the thermoplastic polyurethane using a twin-screw extruder and then extrusion-molding the resultant material.

The antibacterial agent may be prepared by grinding and sintering at least one selected from the group consisting of oyster, scallop, blood cockle, Asian hard clam, mussel, Manila clam, common cockle, Chinese venus clam, pen shell, razor clam, Asian clam, and abalone, preferably at least one selected from the group consisting of oyster, scallop, and blood cockle, and may have antibacterial activity as an alkali salt is generated during grinding and sintering.

The grinding may be performed by using any one equipment selected from a ball mill, an attrition mill, a jet mill, a rotary mill, and a vibration mill so that the mean grain size of is in the range of 1 to 10 μm, preferably 5 to 7 μm. When the mean grain size of the antibacterial agent is less than 1 μm, the antibacterial agent may be difficult to mix well with the thermoplastic polyurethane and the additive and be easy to scatter, contaminating the working environment, and the antibacterial effect may be low. On the other hand, when the mean grain size of the antibacterial agent exceeds 10 μm, the antibacterial agent may precipitate due to the large particle size during mixing and thus may be difficult to mix well with the thermoplastic polyurethane and the additive.

The sintering may be performed at a temperature in the range of 600 to 1,200° C. for 1 to 5 hours. When the sintering temperature and time are less than the above ranges, calcium oxide (CaO) may not be sufficiently produced from calcium carbonate (CaCO₃), which is one of the components of the antibacterial agent. When the sintering temperature and time exceeds the above ranges, the production of calcium oxide (CaO) is not significantly increased compared to the operating time and cost of a furnace, which may be uneconomical.

The antibacterial agent may be included in an amount of 25 to 35 parts by weight, preferably 27 to 30 parts by weight, with respect to 100 parts by weight of the thermoplastic polyurethane. This is because, when the amount of the antibacterial agent is less than 25 parts by weight, the antibacterial activity may be insignificant, and on the other hand, when the amount of the antibacterial agent exceeds 35 parts by weight, the synergistic effect due to the addition of more than necessary is not so remarkable and only the cost is increased. When the above range is satisfied, the antibacterial effect and formulation stability may be excellent.

The antibacterial agent disclosed in the present specification has the advantage of being eco-friendly and harmless to human body by upcycling the discarded shells of oyster, scallop, blood cockle, Asian hard clam, mussel, Manila clam, common cockle, Chinese venus clam, pen shell, razor clam, Asian clam, and abalone, which are dumped into ocean or left on land and are considered the main culprits of coastal pollution, as a raw material for cell phone cases.

Meanwhile, the antibacterial agent may further include a nanocomposite composed of at least one selected from the group consisting of zinc (Zn), silver (Ag), ceramic, and copper (Cu). The nanocomposite may be added in an amount of 1 to 2 parts by weight, with respect to 100 parts by weight of the antibacterial masterbatch. When the amount of the nanocomposite exceeds the above range, it is not preferable because the effect of improving antibacterial performance may not be properly implemented or processing workability may deteriorate. In the present embodiment, the nanocomposite may have a form in which silver, zinc, and copper are doped on the surface of a ceramic core, and thus antibacterial performance may be sustainable for a long period of time.

Since the thermoplastic polyurethane and the additive have been described above in detail in step S10, the descriptions thereof will be omitted here.

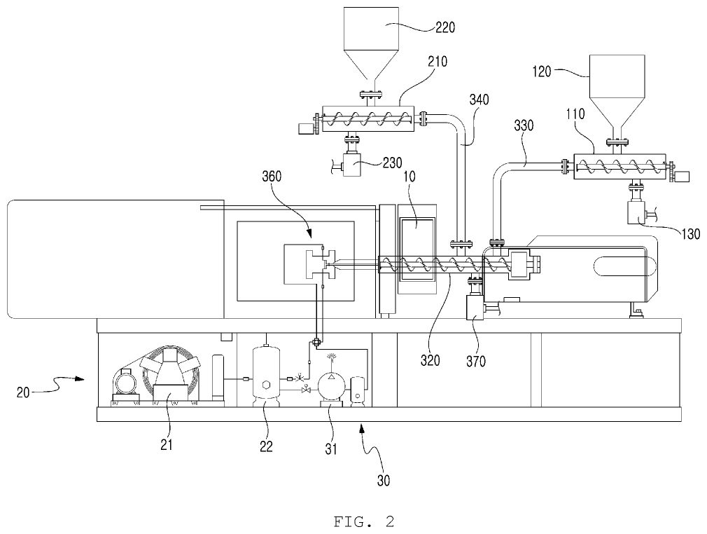

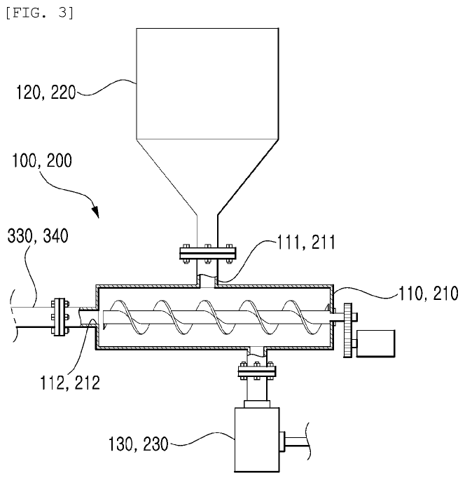

FIG. 2 is an overall schematic view illustrating a facility used in an injection molding process. FIG. 3 is a schematic view illustrating a mixer 100 and 200.

As can be seen in the example of FIG. 2, the facility used in the injection molding process may include a controller 10, a pressurization unit 20, a compressor 21, a storage tank 22, a vacuum unit 30, a vacuum ejector 31, and the like. For example, the controller 10 may control the compressor 21, the vacuum ejector 31, and the like. The functions of the pressurization unit 20, the compressor 21, the storage tank 22, the vacuum unit 30, the vacuum ejector 31, and the like are the same as the functions of those used in a general injection molding process, and detailed descriptions thereof will be omitted here.

Step (c) is performed by a first mixer 100. The first mixer 100 may include a first body 110 having a screw coupled therein and including a first inlet 111 and a first outlet 112, and a first hopper 120 coupled to the first inlet 111 and supplying a color masterbatch. The first mixer 100 may further include a first defoamer supplier 130 supplying a defoamer to the first body 110.

The first mixer 100 disperses the color masterbatch in the thermoplastic polyurethane and mixes the thermoplastic polyurethane and the color masterbatch (S30).

As can be seen in the example of FIG. 2 or FIGS. 3, 1 to 10 parts by weight, preferably 3 to 5 parts by weight, of the color masterbatch prepared in step S10 may be dispersed in 100 parts by weight of the thermoplastic polyurethane in the first mixer 110 and then mixed.

When the amount of the color masterbatch is less than 1 part by weight, it may be difficult to express a desired color. On the other hand, when the amount the color masterbatch exceeds 10 parts by weight, it may be difficult to express a desired color and deep marks on the surface of the finished product may deteriorate the product quality.

As can be seen in the example of FIG. 3, the first mixer 100 may serve to mix the thermoplastic polyurethane and the color masterbatch, and may include the first body 110, the first hopper 120, the first defoamer supplier 130, and the like.

The first body 110 may serve as a housing in which the thermoplastic polyurethane and the color masterbatch are mixed by the screw coupled therein, and may include the first inlet 111 and the first outlet 112.

The first hopper 120 may be coupled to the first inlet 111 of the first body 110, and may serve to supply the color masterbatch to the first body 110.

Meanwhile, in the present embodiment, 0.1 to 5 parts by weight of the defoamer may be added to 100 parts by weight of the thermoplastic polyurethane for the purpose of preventing the quality of the final product from deteriorating due to bubbles generated during dispersion. As the defoamer, a mixture of: 100 parts by weight of fatty acid alcohol in which lauryl alcohol, cetyl alcohol, and stearyl alcohol are mixed in a weight ratio of 1:1:3; 1 to 10 parts by weight of a fatty acid having 15 to 20 carbon atoms; 50 to 80 parts by weight of a nonionic surfactant in which glycerin fatty acid ester and polyoxyethylene fatty acid ester are mixed in a weight ratio of 1:1; 40 to 70 parts by weight of at least one vegetable oil selected from the group consisting of soybean oil, palm oil, corn oil, and rice bran oil; and 30 to 50 parts by weight of at least one mineral oil selected from the group consisting of mineral oil, paraffin oil, and petrolatum may be used, but the present disclosure is not limited thereto.

For example, the first defoamer supplier 130 for supplying the defoamer may be provided at a side of the first body 110. Air bubbles resulting when the color masterbatch is dispersed in the thermoplastic polyurethane may be removed by the defoamer, thereby preventing the quality of the final product from deteriorating due to air bubbles.

A heater (not illustrated) may be mounted at a side of the first body 110, and the thermoplastic polyurethane and the color masterbatch may be melted by the heater. The molten material melted by the heater may be compressed by the screw and moved to an injection molder 300 through a first connector 330 which will be described later.

Step (d) is performed by a second mixer 200. The second mixer 200 may include a second body 210 having a screw coupled therein and including a second inlet 211 and a second outlet 212, and a second hopper 220 coupled to the second inlet 111 and supplying an antibacterial masterbatch. The second mixer 200 may further include a second defoamer supplier 230 supplying a defoamer to the second body 210.

The second mixer 200 disperses the antibacterial masterbatch in the thermoplastic polyurethane and mixes the thermoplastic polyurethane and the antibacterial masterbatch (S40).

As can be seen in the example of FIG. 2 or FIGS. 3, 1 to 15 parts by weight, preferably 3 to 10 parts by weight, of the antibacterial masterbatch prepared in step S20 may be dispersed in 100 parts by weight of the thermoplastic polyurethane in the second mixer 200 and then mixed. In the present embodiment, for the purpose of improving the antibacterial activity, the process of mixing the color masterbatch with the thermoplastic polyurethane in the first mixer 100 and the process of mixing the antibacterial masterbatch with the thermoplastic polyurethane in the second mixer 200 are separately performed. Thus, it is possible to more effectively prevent the antibacterial performance from deteriorating by coating the antibacterial agent with the pigment and to further improve the antibacterial durability and efficacy.

When the amount of the antibacterial masterbatch is less than 1 part by weight, the antibacterial activity may be insignificant. On the other hand, when the amount of the antibacterial masterbatch exceeds 15 parts by weight, defects may occur on the surface of the finished product due to an increase in viscosity.

As can be seen in the example of FIG. 3, the second mixer 100 may serve to mix the thermoplastic polyurethane and the antibacterial masterbatch, and may include the second body 210, the second hopper 220, the second defoamer supplier 230, and the like.

The second body 210 may serve as a housing in which the thermoplastic polyurethane and the antibacterial masterbatch are mixed by the screw coupled therein, and may include the second inlet 211 and the second outlet 212.

The second hopper 220 may be coupled to the second inlet 211 of the second body 210, and may serve to supply the antibacterial masterbatch to the second body 210.

For example, the second defoamer supplier 230 for supplying the defoamer may be provided at a side of the second body 210. Air bubbles resulting when the antibacterial masterbatch is dispersed in the thermoplastic polyurethane may be removed by the defoamer, thereby preventing the quality of the final product from deteriorating due to air bubbles. The details of the defoamer is the same as described above, and the description there of will be omitted here.

A heater (not illustrated) may be mounted at a side of the second body 210, and the thermoplastic polyurethane and the antibacterial masterbatch may be melted by the heater. The molten material melted by the heater may be compressed by the screw and then moved to the injection molder 300 through a second connector 340 which will be described later.

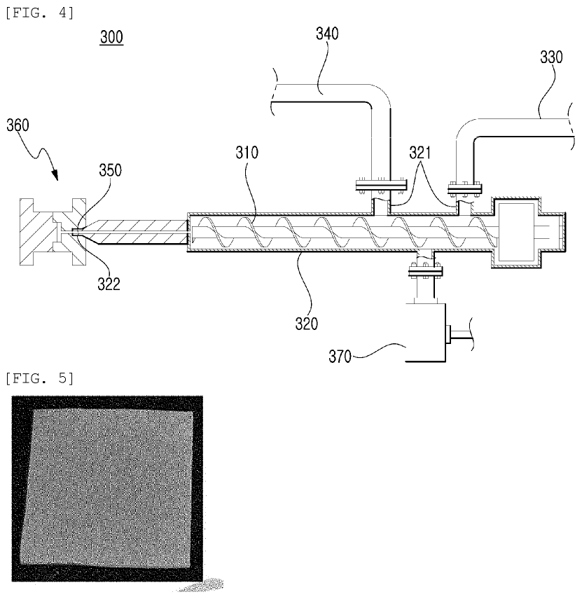

FIG. 4 is a schematic view illustrating the injection molder 300.

Step (e) is performed by the injection molder 300 including a single screw 310. The injection molder 300 may include: a cylinder 320 having a single screw 310 coupled therein and including an injection inlet 321 and an injection outlet 322; the first connector 330 having a first side connected to the first outlet 112 of the first body 110 and a second side connected to the cylinder 320, and supplying the material mixed in the first mixer 100 to the cylinder 320; a second connector 340 having a first side connected to the second outlet 212 of the second body 210 and a second side connected to the cylinder 320, and supplying the material mixed in the second mixer 200 to the cylinder 320; and a molding die 360 connected to a nozzle 350 coupled to the injection outlet 322. The injection molder 300 may further include a third defoamer supplier 370 supplying a defoamer to the cylinder 320. The injection molder 300 may further include a sensor opening and closing each of the first connector 330 and the second connector 340 by measuring the temperature, pressure, and composition ratio inside the cylinder 320.

Finally, the material mixed in the first mixer 100 and the material mixed in the second mixer 200 are mixed in the injection molder 300 and then subjected to injection molding (S50).

As can be seen in the example of FIG. 4, the thermoplastic polyurethane and the color masterbatch mixed in the first mixer 100 and the thermoplastic polyurethane and the antibacterial masterbatch mixed in the second mixer 200 may be mixed in the screw-type injection molder 300 and then injection-molded. In the present embodiment, for the purpose of improving the antibacterial activity, the color masterbatch is dispersed in and mixed with the thermoplastic polyurethane in the first mixer 100 (S30), the antibacterial masterbatch is dispersed and mixed with the thermoplastic polyurethane in the second mixer 200 (S40), and the mixture of first mixer 100 and the mixture of the second mixer 100 are mixed in the injection molder 300. Thus, it is possible to minimize the time and process of mixing the antibacterial component and the color component to thereby more effectively prevent the antibacterial performance from deteriorating and further improve the antibacterial durability and efficacy.

As can be seen in the example of FIG. 4, the injection molder 300 may serve to mix and injection-mold the materials that are mixed in the first and second mixers 100 and 200, respectively, and may include the cylinder 320, the first and second connectors 330 and 340, the nozzle 350, the molding die 360, the third defoamer supplier 370, the sensor, and the like.

The cylinder 320 may be provided with the single screw 310 therein to serve to mix the materials that are introduced from the first and second mixers 100 and 200, respectively, and may include the injection inlet 321 and the injection outlet 322.

As can be seen in the example of FIG. 3 or FIG. 4, the first connector 330 may have the first side connected to the first outlet 112 of the first body 110 and the second side connected to the cylinder 320 and may serve to supply the material mixed in the first mixer 100 to the cylinder 320. The second connector 340 may have the first side connected to the second outlet 212 of the second body 210 and the second side connected to the cylinder 320 and may serve to supply the material mixed in the second mixer 200 to the cylinder 320.

For example, a heater may be mounted at a side of the cylinder, and the thermoplastic polyurethane, the color masterbatch, and the antibacterial masterbatch may be melted by the heater. The molten material melted by the heater may be compressed by the single screw 310 and then injected into the molding die 360 through the nozzle 350 to form a product 1.

In addition, the third defoamer supplier 370 for supplying the defoamer may be provided at a side of the cylinder 320.

For example, air bubbles resulting when the mixture of the first mixer 100 and the mixture of the second mixer 200 are dispersed and mixed may be removed by the defoamer, thereby preventing the quality of the final product 1 from deteriorating due to air bubbles.

For example, the sensor (not illustrated) may measure the temperature, pressure, composition ratio, etc. inside the cylinder 320, and may control the internal state of the cylinder 320 in accordance with the conditions inside the cylinder 320. For example, the sensor may control the amount of mixture introduced into the cylinder 320 from the first mixer 100 or the second mixer 200 by opening and closing the first connector 330 or the second connector 340 in accordance with the conditions inside the cylinder 320, respectively.

When the injection molding as described above is completed, a final antibacterial mobile phone case is obtained. The antibacterial phone case thus obtained exhibits a clear color, a smooth surface, and excellent quality.

### Example 1. Manufacturing of Antibacterial Phone Case

20 g of Chinese venus clam shells having a mean grain size of 5 to 7 μm and 10 g of a phenol-based antioxidant and dispersant were dispersed in 70 g of thermoplastic polyurethane at 300 to 400 rpm using a twin-screw extruder, and then extrusion-molded to prepare a pellet-shaped antibacterial masterbatch. Then, 20 g of G7 and rutile TiO₂, and 10 g of a phenol-based antioxidant and dispersant were dispersed in 70 g of thermoplastic polyurethane at 300 to 400 rpm using a twin-screw extruder, and then extrusion-molded to prepare a pellet-shaped color masterbatch. After mixing 50 g of the color masterbatch with 1,000 g of thermoplastic polyurethane using the first mixer 100 and mixing 70 g of the antibacterial masterbatch with 1,000 g of thermoplastic polyurethane using the second mixer 200, the materials mixed in the first mixer 100 and the second mixer 200 were mixed in the injection molder 300 and then injection-molded. Thus, an antibacterial mobile phone case was manufactured.

### Experimental Example 1. Evaluation of Antibacterial Performance

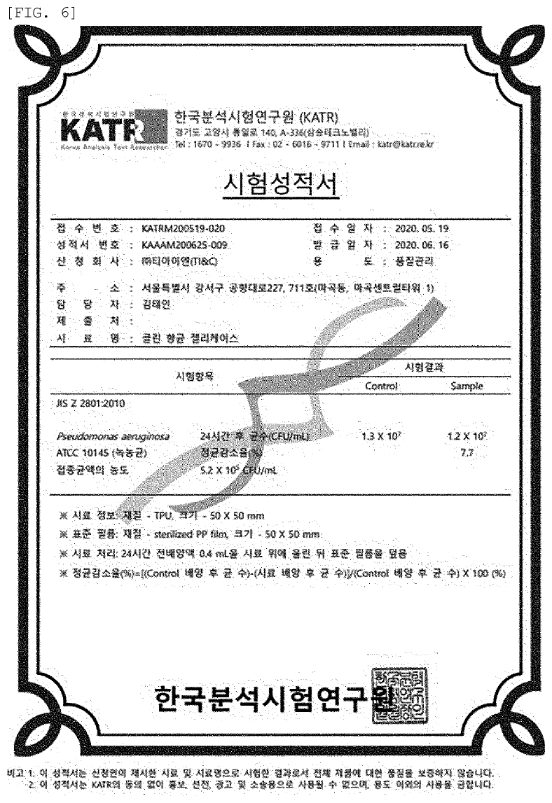

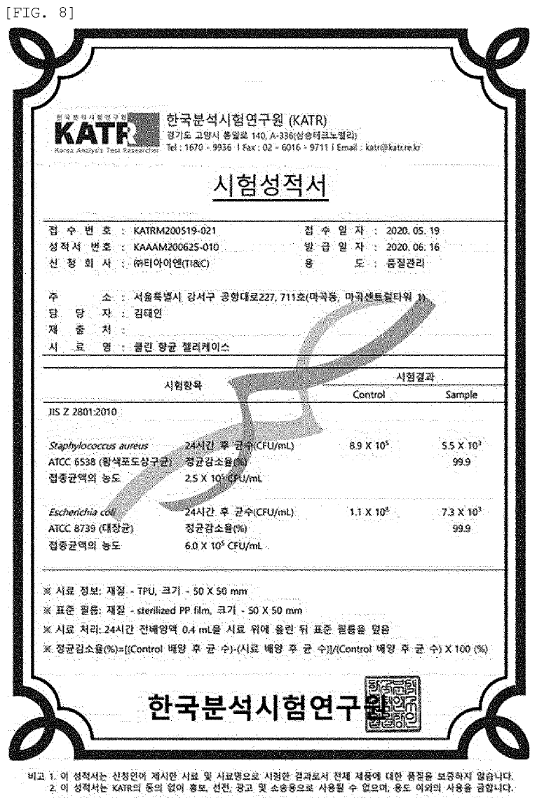

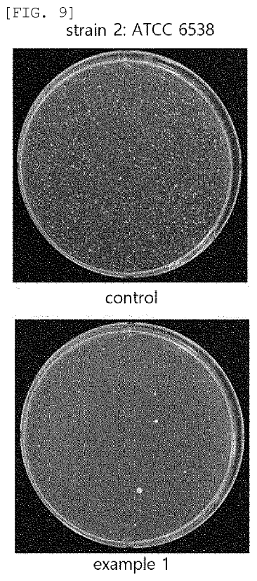

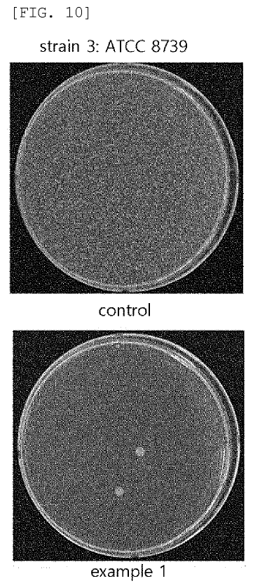

In order to evaluate the antimicrobial activity against pathogens of an antibacterial jelly case according to Example 1, an experiment was commissioned by the Korea Analysis Test Researcher. FIGS. 5 to 9 are test results and images provided by the Korea Analysis Test Researcher.

The experiment was performed according to JIS Z 2801:2010.

As test strains, Pseudomonas aeruginosa ATCC 10145 (strain 1), Staphylococcus aureus ATCC 6538 (strain 2), and Escherichia coli ATCC 8739 (strain 3) were used. As a control, a polypropylene film (PP film) was used.

First, a test bacterial solution was prepared for each strain, and the initial number of bacteria was measured. Then, as illustrated in FIG. 5, each of the antibacterial jelly case of Example 1 and the polypropylene film of the control was prepared in a size of 50 cm×50 cm, and 0.4 ml of the test bacterial solution was dropped onto the film which was then covered with a cover film. Under conditions of room temperature and humidity, stationary culture was performed for 24 hours in the presence of light irradiation using a fluorescent lamp. Thereafter, the number of bacteria was measured.

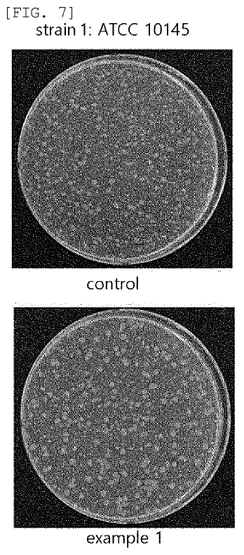

Referring to FIGS. 6 to 10, the results show that the antibacterial jelly case of Example 1 exhibited a very low bacterial reduction rate of 7.7% against strain 1 (Pseudomonas aeruginosa), whereas the bacterial reduction rate was close to 100% against both strain 2 (Staphylococcus aureus) and strain 3 (Escherichia coli).

While the present disclosure has been particularly shown and described with reference to an exemplary embodiment thereof, it will be understood by those skilled in the art that various changes and modifications may be made therein without departing from the technical idea and scope of the present disclosure and such changes and modifications belong to the claims of the present disclosure.

What is claimed is:

1. A method of manufacturing an antibacterial mobile phone case using a TPU antibacterial masterbatch, the method comprising:
(a) preparing an antibacterial masterbatch by dispersing an antibacterial agent and an additive in thermoplastic polyurethane and then performing extrusion molding;
(b) preparing an antibacterial masterbatch by dispersing an antibacterial agent and an additive in thermoplastic polyurethane and then performing extrusion molding;
(c) dispersing and mixing the color masterbatch prepared in step (a) in thermoplastic polyurethane;
(d) dispersing and mixing the antibacterial masterbatch prepared in step (b) in thermoplastic polyurethane; and
(e) dispersing the material mixed in step (c) and the material mixed in step (d) and then performing injection molding,
wherein in step (a), 25 to 35 parts by weight of the pigment and 10 to 20 parts by weight of the additive are dispersed in 100 parts by weight of the thermoplastic polyurethane,
in step (b), 25 to 35 parts by weight of the antibacterial agent and 10 to 20 parts by weight of the additive are dispersed in 100 parts by weight of the thermoplastic polyurethane,
in step (c), 1 to 10 parts by weight of the color masterbatch are dispersed in 100 parts by weight of the thermoplastic polyurethane, and
in step (d), 1 to 15 parts by weight of the antibacterial masterbatch are dispersed in 100 parts by weight of the thermoplastic polyurethane, and
wherein step (c) is performed by a first mixer,
the first mixer comprising:
a first body having a screw coupled therein and including a first inlet and a first outlet; and
a first hopper coupled to the first inlet and configured to supply the color masterbatch prepared in step (a),
step (d) is performed by a second mixer,
the second mixer comprising:
a second body having a screw coupled therein and including a second inlet and a second outlet; and
a second hopper coupled to the second inlet and configured to supply the antibacterial masterbatch prepared in step (b),
step (e) is performed by an injection molder including a single screw,
the injection molder comprising:
a cylinder having a single screw coupled therein and including an injection inlet and an injection outlet;
a first connector having a first side connected to the first outlet of the first body and a second side connected to the cylinder, and configured to supply the material mixed in the first mixer to the cylinder;
a second connector having a first side connected to the second outlet of the second body and a second side connected to the cylinder, and configured to supply the material mixed in the second mixer to the cylinder; and
a molding die connected to a nozzle coupled to the injection outlet, and
the materials produced in steps (a) and (b) are not immediately mixed in step (e) but separately mixed in steps (c) and (d) before step (e) using the first and second mixers, respectively, and then step (e) is performed by the injection molder, whereby it is possible to minimize the time and process for mixing the antibacterial component and the color component to thereby prevent antibacterial performance from deteriorating.

2. The method of claim 1, wherein the extrusion molding in step (a) and step (b) is performed by a twin-screw extruder.

3. The method of claim 1, wherein the first mixer further comprises a first defoamer supplier configured to supply a defoamer to the first body.

4. The method of claim 1, wherein the injection molder further comprises a third defoamer supplier configured to supply a defoamer to the cylinder.

5. The method of claim 1, wherein the injection molder further comprises a sensor configured to open and close each of the first and second connectors by measuring temperature, pressure, and composition ratio inside the cylinder.
